(19) United States
(12) Patent Application Publication
(10) Pub. No.: US 2025/0242684 A1
(43) Pub. Date: Jul. 31, 2025

(54) COOLING CIRCUIT AND VEHICLE DRIVING APPARATUS

(71) Applicant: Honda Motor Co., Ltd., Tokyo (JP)

(72) Inventors: Toshifumi YAMADA, Tokyo (JP); Mitsuhiro TAKEDA, Tokyo (JP); Yoshiomi SHIMAZU, Tokyo (JP); Jumpei KANETA, Tokyo (JP)

(73) Assignee: Honda Motor Co., Ltd., Tokyo (JP)

(21) Appl. No.: 19/006,261

(22) Filed: Dec. 31, 2024

(30) Foreign Application Priority Data
Jan. 31, 2024 (JP) 2024-013679

(51) Int. Cl. B60K 11/02

(52) U.S. Cl. CPC B60K 11/02

(57) ABSTRACT

A cooling circuit includes: a first cooling circuit 4A in which oil 8 is pumped by a first pump 10A as a first refrigerant 8A and passes through a first heat exchanger 12A to cool a first cooled part 14A; a second cooling circuit 4B in which oil 8 is pumped by a second pump 10B as a second refrigerant 8B and passes through a second heat exchanger 12B to cool a second cooled part 14B; and a third cooling circuit 4C including a third heat exchanger 16A and a fourth heat exchanger 16B through which a water-soluble refrigerant passes, and a radiator 20. The third heat exchanger 16A and the fourth heat exchanger 16B are arranged in series. The first cooling circuit 4A and the second cooling circuit 4B converge between the downstream side of the first heat exchanger 12A 10 and the second heat exchanger 12B and the upstream side of the first cooled part 14A and the second cooled part 14B, and the first cooled part 14A and the second cooled part 14B are cooled by a refrigerant 8C after confluence.

### CROSS-REFERENCE TO RELATED APPLICATION

This application claims the priority benefit of Japanese application serial no. 2024-013679, filed on Jan. 31, 2024. The entirety of the above-mentioned patent application is hereby incorporated by reference herein and made a part of this specification.

### BACKGROUND

### Technical Field

The disclosure relates to a cooling circuit and a vehicle driving apparatus including the cooling circuit.

### Description of Related Art

In recent years, vehicle electrification has been progressing rapidly. As the systems for transmitting the drive torque from a motor to drive wheels, there are known a system using a single motor unit (hereinafter abbreviated as SMU) to distribute the drive torque of a single motor to the left and right via a differential device and transmit the drive torque to the left and right drive wheels; and a system using a twin motor unit (hereinafter abbreviated as TMU) with independent left and right motors to independently transmit the motor torque to each of the left and right drive wheels for precise control of left and right drive forces.

TMU is only used in some high-grade vehicles, sports vehicles, vehicles designed for off-road driving, or the like. As the production volume of TMU-equipped vehicles is lower than the production volume of SMU-equipped vehicles, depreciation is slow, which leads to a problem of high costs. To produce TMU-equipped vehicles with a small production quantity at lower costs, it is necessary to use as many parts as possible from the base SMU. Therefore, not only parts of the cooled part such as motor and gears are used from the SMU, but it is also necessary to use parts such as electric oil pump (EOP) and heat exchanger. This is because newly manufacturing larger capacity parts compared to SMU parts would result in higher costs.

Patent Document 1 (Japanese Patent Application Laid-Open No. 2022-94849) discloses a cooling system that connects a first path cooling a cooling target composed of one set of motor and inverter, and a second path cooling a cooling target also composed of one set of motor and inverter, by a single reservoir tank, for circulation. The reservoir tank is partitioned by a partition part corresponding to each path, and is formed so that the refrigerant introduced from each path partially merges above the partition part. The partial confluence configuration enables the refrigerant to flow in a series path connecting the first path and the second path in series. The partition configuration of the reservoir tank is provided to enable the continuation of refrigerant circulation (cooling of the drive path) in the other path in case of refrigerant leakage in either path.

Since the capacity is insufficient with only one SMU part, a TMU-equipped vehicle includes two of the same oil pump and heat exchanger as the SMU, and attempts to reduce costs with a structure that cools the left and right mechanisms with respective oil cooling circuits. On the other hand, the cooling lubricating oil such as transmission fluid that circulates in each oil cooling circuit and cools and lubricates the motor and gears is cooled by (exchanges heat with) a water cooling circuit. The cooling efficiency of the water cooling circuit depends on the water flow supply amount and water temperature, but from the relationship between water supply amount and cooling efficiency of the water cooling circuit, when there is only one system for supply, it is desirable to connect the two heat exchangers in series in the water cooling circuit. This is because the total heat exchange efficiency is higher when cooling the left and right oil cooling circuits in series with a large flow rate, rather than dividing the water cooling circuit and cooling the left and right oil cooling circuits individually with half the flow rate.

However, in the case of a series system, the cooling temperature changes between the upstream and downstream heat exchangers, resulting in changes in the cooling temperatures of the left and right motors, gears, bearings, and other devices in the vehicle. This may lead to changes in the cooling balance, heat balance, performance balance, and lifespan between the left and right sides of the vehicle.

The disclosure provides a cooling circuit that can maintain the cooling balance of vehicles with high cooling efficiency, and thus contribute to the widespread adoption of TMU-equipped vehicles with a cost-effective configuration.

### SUMMARY

A cooling circuit (4) of the disclosure includes: a first cooling circuit (4A) including a first pump (10A) that pumps a refrigerant (8) stored in a refrigerant storage part (6) as a first refrigerant (8A), a first heat exchanger (12A) that adjusts a temperature of the first refrigerant (8A), and a first cooled part (14A); a second cooling circuit (4B) including a second pump (10B) that pumps the refrigerant (8) stored in the refrigerant storage part (6) as a second refrigerant (8B), a second heat exchanger (12B) that adjusts a temperature of the second refrigerant (8B), and a second cooled part (14B); and a third cooling circuit (4C) including a third pump (24) that pumps a third refrigerant (18), a third heat exchanger (16A) that exchanges heat with the first heat exchanger (12A), a fourth heat exchanger (16B) that exchanges heat with the second heat exchanger (12B), and a fifth heat exchanger (20) that adjusts a temperature of the third refrigerant (18), in which the third heat exchanger (16A) and the fourth heat exchanger (16B) are arranged in series in the third cooling circuit (4C), and the first cooling circuit (4A) and the second cooling circuit (4B) converge between a downstream side of the first heat exchanger (12A) and the second heat exchanger (12B) and an upstream side of the first cooled part (14A) and the second cooled part (14B) in a refrigerant circulation direction.

### BRIEF DESCRIPTION OF THE DRAWINGS

FIG. 1 is a schematic diagram of the cooling circuit of the vehicle driving apparatus according to the first embodiment of the disclosure.

FIG. 2 is a detailed diagram of the cooling circuit of the vehicle driving apparatus shown in FIG. 1.

FIG. 3 is a detailed diagram of the first cooled part and the second cooled part in the cooling circuit shown in FIG. 1.

FIG. 4 is a detailed diagram of the cooling circuit of the vehicle driving apparatus according to the second embodiment.

FIG. 5 is a partially omitted diagram showing the backup configuration in case one of the pumps fails in the cooling circuit shown in FIG. 4.

FIG. 6 is a partially omitted diagram showing the backup configuration in case the other pump fails in the cooling circuit shown in FIG. 4.

FIG. 7 is a detailed diagram of the cooling circuit of the vehicle driving apparatus according to the third embodiment.

FIG. 8 is a partially omitted diagram showing the backup configuration in case one of the cooling circuits fails in the cooling circuit shown in FIG. 7.

FIG. 9 is a partially omitted diagram showing the backup configuration in case the other cooling circuit fails in the cooling circuit shown in FIG. 7.

FIG. 10A and FIG. 10B are diagrams for illustrating problems that occur due to the configuration of the water cooling circuit, wherein FIG. 10A is a diagram showing the case when the water cooling circuit is divided, and FIG. 10B is a diagram showing the case when the water cooling circuit is connected in series to form a single system.

### DESCRIPTION OF THE EMBODIMENTS

A cooling circuit (4) of the disclosure includes: a first cooling circuit (4A) including a first pump (10A) that pumps a refrigerant (8) stored in a refrigerant storage part (6) as a first refrigerant (8A), a first heat exchanger (12A) that adjusts a temperature of the first refrigerant (8A), and a first cooled part (14A); a second cooling circuit (4B) including a second pump (10B) that pumps the refrigerant (8) stored in the refrigerant storage part (6) as a second refrigerant (8B), a second heat exchanger (12B) that adjusts a temperature of the second refrigerant (8B), and a second cooled part (14B); and a third cooling circuit (4C) including a third pump (24) that pumps a third refrigerant (18), a third heat exchanger (16A) that exchanges heat with the first heat exchanger (12A), a fourth heat exchanger (16B) that exchanges heat with the second heat exchanger (12B), and a fifth heat exchanger (20) that adjusts a temperature of the third refrigerant (18), in which the third heat exchanger (16A) and the fourth heat exchanger (16B) are arranged in series in the third cooling circuit (4C), and the first cooling circuit (4A) and the second cooling circuit (4B) converge between a downstream side of the first heat exchanger (12A) and the second heat exchanger (12B) and an upstream side of the first cooled part (14A) and the second cooled part (14B) in a refrigerant circulation direction.

According to the cooling circuit of the disclosure, the temperature unevenness between the first cooling circuit and the second cooling circuit, caused by arranging the third heat exchanger and the fourth heat exchanger in series in the third cooling circuit, is corrected by the confluence. Therefore, the cooling balance of the vehicle can be maintained, and changes in the heat balance, performance balance, and lifespan between the left and right sides of the vehicle can be suppressed. This can contribute to reducing the costs of TMU-equipped vehicles, and thus to widespread adoption.

In addition, in the above cooling circuit (4), the refrigerant (8) may be oil.

Furthermore, in the above cooling circuit (4), the third refrigerant (18) may be a water-soluble refrigerant.

Moreover, in the above cooling circuit (4), the fifth heat exchanger (20) may be a radiator that exchanges heat with outside air.

Furthermore, in the above cooling circuit (4), the first heat exchanger (12A) and the second heat exchanger (12B) may have the same structure. According to this, since there is little change in heat balance, the cooling balance of the vehicle can be maintained with high precision.

Moreover, in the above cooling circuit (4), the third heat exchanger (16A) and the fourth heat exchanger (16B) may have the same structure. According to this, since there is little change in heat balance, the cooling balance of the vehicle can be maintained with high precision.

Furthermore, in the above cooling circuit (4), the first cooled part (14A) and/or the second cooled part (14B) may be a motor.

Moreover, in the above cooling circuit (4), the first cooled part (14A) and the second cooled part (14B) may be motors with the same structure. According to this, since there is little change in heat balance between the two motors, the cooling balance of the vehicle can be maintained with high precision.

Furthermore, in the above cooling circuit (4), the first pump (10A) and the second pump (10B) may be pumps with the same structures. According to this, since there is little performance difference between the two pumps, the cooling balance of the vehicle can be maintained with high precision.

Moreover, in the above cooling circuit (4), the first pump (10A) and the second pump (10B) may be electric pumps. According to this, the control of suction and discharge amounts becomes easy.

Furthermore, the above cooling circuit (4) may be configured to include: a first pump failure detection part (42A) detecting a failure of the first pump (10A); a second pump failure detection part (42B) detecting a failure of the second pump (10B); a first valve (44A) arranged between the first heat exchanger (12A) and the first cooled part (14A) of the first cooling circuit (4A); a second valve (44B) arranged between the second heat exchanger (12B) and the second cooled part (14B) of the second cooling circuit (4B); and a controller (36) configured to close the first valve (44A) in response to the first pump failure detection part (42A) detecting a failure of the first pump (10A), and close the second valve (44B) in response to the second pump failure detection part (42B) detecting a failure of the second pump (10B). According to this, even if one pump fails, the cooling circuit operated by the other pump can function as a backup, enabling temporary driving to a repair facility such as a dealer.

Moreover, in the above cooling circuit (4), the controller (36) may be configured to increase output of the second pump (10B) in response to the first pump failure detection part (42A) detecting a failure of the first pump (10A), and increase output of the first pump (10A) in response to the second pump failure detection part (42B) detecting a failure of the second pump (10B).

According to this, it is possible to suppress the decrease in cooling efficiency due to the reduction in refrigerant amount when cooling the first cooled part and the second cooled part with only a single cooling circuit (either the first cooling circuit or the second cooling circuit), enabling temporary driving to a repair facility such as a dealer.

Furthermore, the above cooling circuit (4) may include: a first flow rate sensor (46A) detecting a refrigerant flow rate of the first cooling circuit (4A); and a second flow rate sensor (46B) detecting a refrigerant flow rate of the second cooling circuit (4B), in which the controller (36) is configured to determine that the first cooling circuit (4A) has failed and close the first valve (44A) in response to the first flow rate sensor (46A) detecting that a discharge flow rate of the first pump (10A) falls to or below a level for a predetermined time or longer, and determine that the second cooling circuit (4B) has failed and close the second valve (44B) in response to the second flow rate sensor (46B) detecting that a discharge flow rate of the second pump (10B) falls to or below a level for a predetermined time or longer. According to this, even if one pump fails, the cooling circuit operated by the other pump can function as a backup, enabling temporary driving to a repair facility such as a dealer.

Moreover, a vehicle driving apparatus (2A, 2B, 2C) of the disclosure includes the above cooling circuit (4). With the vehicle driving apparatus according to the disclosure, the effects of the above cooling circuit can be achieved.

Furthermore, the vehicle driving apparatus (2A, 2B, 2C) of the disclosure includes: a first pump failure detection part (42A) detecting a failure of the first pump (10A); a second pump failure detection part (42B) detecting a failure of the second pump (10B); a first valve (44A) arranged between the first heat exchanger (12A) and the first cooled part (14A) of the first cooling circuit (4A); a second valve (44B) arranged between the second heat exchanger (12B) and the second cooled part (14B) of the second cooling circuit (4B); and a controller (36) configured to close the first valve (44A) in response to the first pump failure detection part (42A) detecting a failure of the first pump (10A), and close the second valve (44B) in response to the second pump failure detection part (42B) detecting a failure of the second pump (10B), and includes: a controller (36) configured to reduce functions of the first cooled part (14A) and the second cooled part (14B) in response to the first pump failure detection part (42A) detecting a failure of the first pump (10A) and/or in response to the second pump failure detection part (42B) detecting a failure of the second pump (10B). With the vehicle driving apparatus according to the disclosure, in the case of a failure of the first pump or the second pump, it is possible to suppress a rapid decrease in cooling efficiency by adjusting the output to correspond to the reduced oil (first refrigerant or second refrigerant) flow rate.

According to the disclosure, it is possible to maintain the cooling balance of vehicles with high cooling efficiency, and thus contribute to the widespread adoption of TMU-equipped vehicles with a cost-effective configuration.

The embodiments of the disclosure are described hereinafter with reference to the attached figures. In each figure, the flow path (piping) and the fluid (refrigerant) flowing therethrough are shown as a single line without distinction.

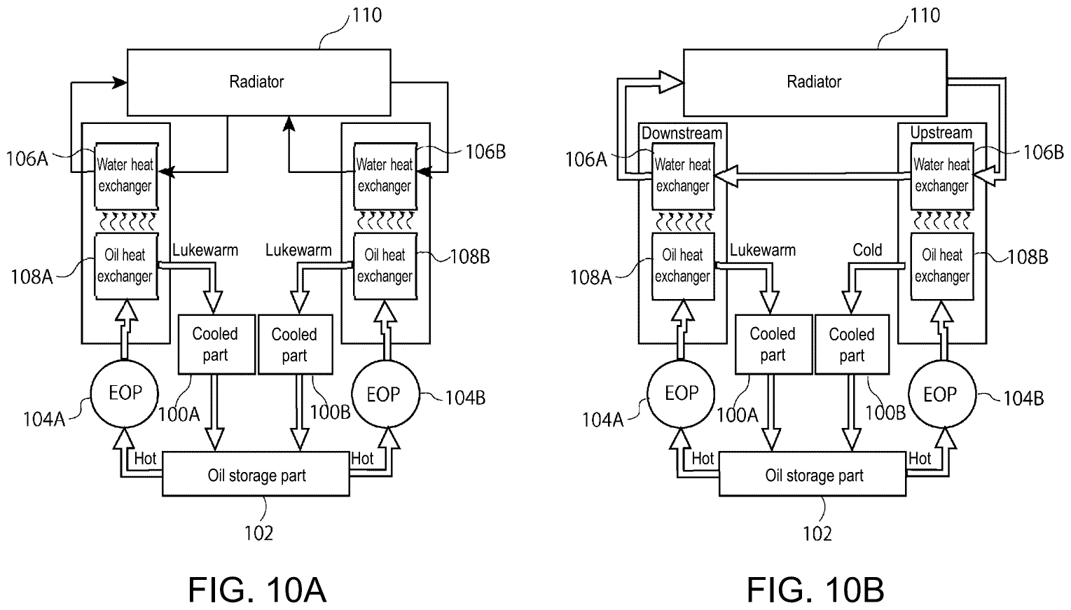

Before explaining this embodiment, specific problems with dividing the water cooling circuit and connecting the water cooling circuit in series are illustrated. FIG. 10A is an example where, in a configuration cooling two cooled parts 100A and 100B including the motor and gears with respective oil cooling circuits, the water cooling circuit is divided to halve the flow rate and exchange heat with the left and right oil cooling circuits. In each oil cooling circuit, oil is drawn from an oil storage part 102 by electric oil pumps 104A and 104B, and circulates through a path cooling the cooled parts 100A and 100B through oil heat exchangers 108A and 108B that exchange heat with water heat exchangers 106A and 106B. In the water cooling circuit, after exchanging heat with the oil heat exchangers 108A and 108B, the water is air-cooled by a radiator 110 and then resupplied by water pumps (not shown). In the case of this configuration, no thermal unevenness occurs in each oil cooling circuit. However, the water flow supply amount in the left and right water cooling circuits is small, and since the cooling efficiency of the water cooling circuit depends on the water flow supply amount, the heat exchange rate with the oil heat exchangers 108A and 108B is low, the oil discharged from the oil heat exchangers 108A and 108B is not sufficiently cooled and becomes lukewarm, which results in a decrease in the cooling efficiency of the cooled parts 100A and 100B.

FIG. 10B shows a configuration in which the water cooling circuit is not divided but is a single system, and which cools the left and right oil cooling circuits in series. As the water flow supply amount in the water cooling circuit increases, the total heat exchange rate improves. However, the cooling efficiency for the oil heat exchangers 108A and 108B changes between the upstream side and downstream side of the flow path of the water cooling circuit. That is, the oil discharged from the upstream oil heat exchanger 108B becomes cold due to the high heat exchange rate with the water heat exchanger 106B, whereas the oil discharged from the downstream oil heat exchanger 108A becomes lukewarm due to the low heat exchange rate with the water heat exchanger 106A. As a result, it is unavoidable that the cooling efficiency changes between the cooled parts 100A and 100B, causing thermal unevenness. If the thermal unevenness state is left unaddressed for a long time, the balance of performance and durability (lifespan) between the cooled parts 100A and 100B may be easily disrupted. This problem occurs similarly in the cooling circuit in the case of configuring TMU at low costs by using parts from SMU.

### First Embodiment

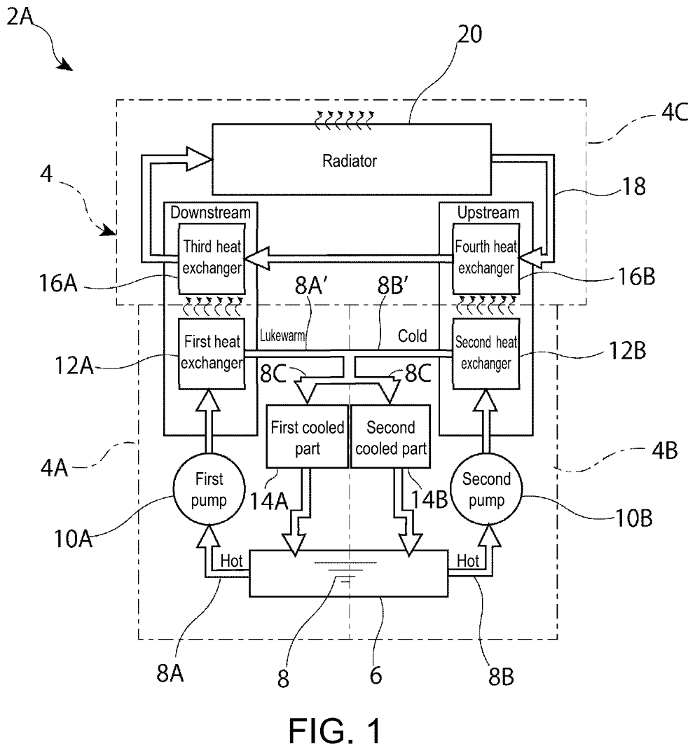

The outline of this embodiment for resolving the above problem will be described with reference to FIG. 1. FIG. 1 shows the cooling circuit of a motor driving apparatus that individually drives the left and right drive wheels of a TMU-equipped vehicle.

A vehicle driving apparatus 2A includes a cooling circuit 4. The cooling circuit 4 includes a first cooling circuit 4A, a second cooling circuit 4B, and a third cooling circuit 4C. The first cooling circuit 4A includes a first pump 10A pumping oil 8, which serves as a refrigerant stored in an oil tank 6 that is a refrigerant storage part, as a first refrigerant 8A; a first heat exchanger 12A connected in series with the first pump 10A and adjusting the temperature of the first refrigerant 8A; and a first cooled part 14A. The second cooling circuit 4B includes a second pump 10B pumping the oil 8 stored in the oil tank 6 as a second refrigerant 8B; a second heat exchanger 12B connected in series with the second pump 10B and adjusting the temperature of the second refrigerant 8B; and a second cooled part 14B. The third cooling circuit 4C includes a third pump (described later) pumping a third refrigerant 18; a third heat exchanger 16A exchanging heat with the first heat exchanger 12A; a fourth heat exchanger 16B exchanging heat with the second heat exchanger 12B; and a radiator 20 serving as a fifth heat exchanger that adjusts the temperature of the third refrigerant 18 and exchanging heat with the outside air. The first heat exchanger 12A and the second heat exchanger 12B have the same structure, and the third heat exchanger 16A and the fourth heat exchanger 16B also have the same structure.

The first pump 10A and the second pump 10B are both electric oil pumps (EOPs) with the same structure. The temperature of the first refrigerant 8A supplied to the first heat exchanger 12A by the first pump 10A and the temperature of the second refrigerant 8B supplied to the second heat exchanger 12B by the second pump 10B are approximately the same. The third refrigerant 18 is composed of a water-soluble refrigerant, specifically using a long-life coolant (LLC) mixed with antifreeze. Water may also be used as the third refrigerant 18.

The third heat exchanger 16A and the fourth heat exchanger 16B are arranged (connected) in series in the third cooling circuit 4C, and the first cooling circuit 4A and the second cooling circuit 4B are configured to converge between the downstream side of the first heat exchanger 12A and the second heat exchanger 12B and the upstream side of the first cooled part 14A and the second cooled part 14B in the refrigerant circulation direction. The refrigerant circulation direction refers to the direction in which the first refrigerant 8A and the second refrigerant 8B circulate. In the third cooling circuit 4C, the third heat exchanger 16A and the fourth heat exchanger 16B are arranged in series so as not to disperse the supply amount of the third refrigerant 18. Therefore, compared to the configuration of parallel arrangement shown in FIG. 10A, this configuration can increase the total efficiency of the first heat exchange between the first heat exchanger 12A and the third heat exchanger 16A, and the second heat exchange between the second heat exchanger 12B and the fourth heat exchanger 16B, and simultaneously allow for a simple, lightweight, and cost-effective construction of the third cooling circuit 4C.

However, due to the series arrangement of the third heat exchanger 16A and the fourth heat exchanger 16B, the temperature of the third refrigerant 18 is higher on the downstream side in the circulation direction of the third refrigerant 18. Consequently, the oil temperatures after heat exchange in the first heat exchanger 12A and the second heat exchanger 12B differ. This results in thermal unevenness between the first cooled part 14A and the second cooled part 14B, leading to different cooling temperatures. To prevent potential malfunctions of the apparatus caused by this non-uniform cooling temperature, in this embodiment, the first refrigerant 8A′ and the second refrigerant 8B′ discharged from the first heat exchanger 12A and the second heat exchanger 12B, at the respective temperatures, are merged before being supplied to the first cooled part 14A and the second cooled part 14B. The refrigerant 8C, with temperature uniformized by the confluence, is then supplied to the first cooled part 14A and the second cooled part 14B, respectively. This makes it possible to maintain the cooling balance of the vehicle with high cooling efficiency, and suppress changes in the heat balance, performance balance, and lifespan between the left and right sides of the vehicle.

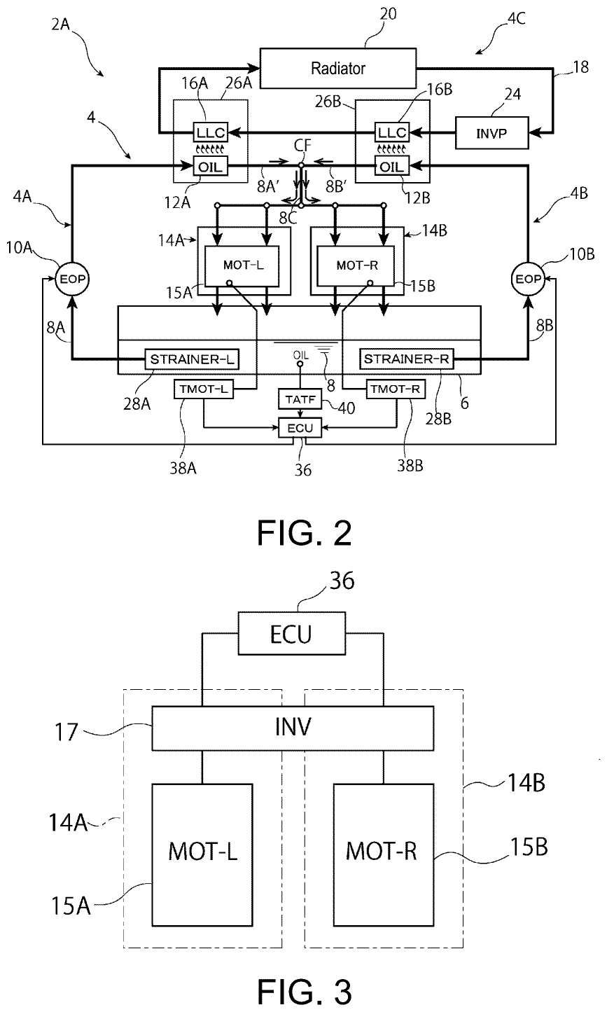

This embodiment will be described specifically with reference to FIG. 2. In the third cooling circuit 4C, the third refrigerant 18 air-cooled by the radiator 20 is pumped to the fourth heat exchanger 16B by the third pump 24 composed of an inverter pump. From the viewpoint of using as many parts of SMU as possible, two inverter pumps may be used in combination as the third pump 24. Reference numerals 26A and 26B indicate water-cooled oil coolers. The oil 8 stored in the oil tank 6 is drawn as the first refrigerant 8A via a strainer 28A on the left side of the figure by the first pump 10A, and as the second refrigerant 8B via a strainer 28B on the right side of the figure by the second pump 10B. In this embodiment, the oil 8 stored in the oil tank 6 is automatic transmission fluid (ATF), but the oil 8 may also be battery electric vehicle fluid (BEVF) for secondary battery electric vehicles.

The first refrigerant 8A′ that has passed through the first heat exchanger 12A and the second refrigerant 8B′ that has passed through the second heat exchanger 12B merge at a confluence part CF, and after their temperatures are uniformized, the refrigerant is divided into left and right branches to cool the first cooled part 14A and the second cooled part 14B. As shown in detail in FIG. 3, the first cooled part 14A includes a left motor 15A and an inverter 17 that drives the motor 15A, while the second cooled part 14B includes a right motor 15B and an inverter 17 that drives the motor 15B. FIG. 2 shows only the motor 15A and the motor 15B. The motor 15A and the motor 15B are motors with the same structure. Here, “the same structure” also includes cases where there may be slight structural differences but the heat balance is almost the same. The driving of the first pump 10A and the second pump 10B is controlled by an ECU (Electronic Control Unit) 36 which serves as a controller. The ECU 36 includes a microcomputer having CPU, ROM, RAM, interface, etc. The ECU 36 receives input of detection values respectively from a motor temperature detection sensor 38A that detects the temperature of the left motor 15A, a motor temperature detection sensor 38B that detects the temperature of the right motor 15B, and an oil temperature detection sensor 40 that detects the temperature of the oil 8 in the oil tank 6.

As shown in FIG. 3, the ECU 36 also serves as a drive controller that controls the driving of the motors 15A and 15B via the inverters 17 (omitted in FIG. 2). Of course, the controller for the cooling circuit 4 and the drive controller for the vehicle driving apparatus 2A may be configured separately and connected in a communicable manner.

According to this embodiment, the temperature unevenness in the oil cooling circuits (the first cooling circuit 4A and the second cooling circuit 4B) caused by the series arrangement of the water cooling circuit (the third cooling circuit 4C) is corrected by confluence. This makes it possible to simplify the configuration of the water cooling circuit while maintaining the cooling balance of the vehicle with high cooling efficiency, and suppress changes in heat balance, performance balance, and lifespan between the left and right sides of the vehicle. This can also contribute to cost reduction and widespread adoption of TMU-equipped vehicles through use of SMU parts.

The cooling system disclosed in Patent Document 1 allows the refrigerant to circulate in a series path by partially converging the same refrigerant circuit at the reservoir tank. The temperature of each refrigerant before confluence can be considered almost the same, and there is no issue of temperature unevenness between the same refrigerant circuits due to heat exchange with a different type of refrigerant (the third refrigerant 18 in this embodiment).

### Second Embodiment

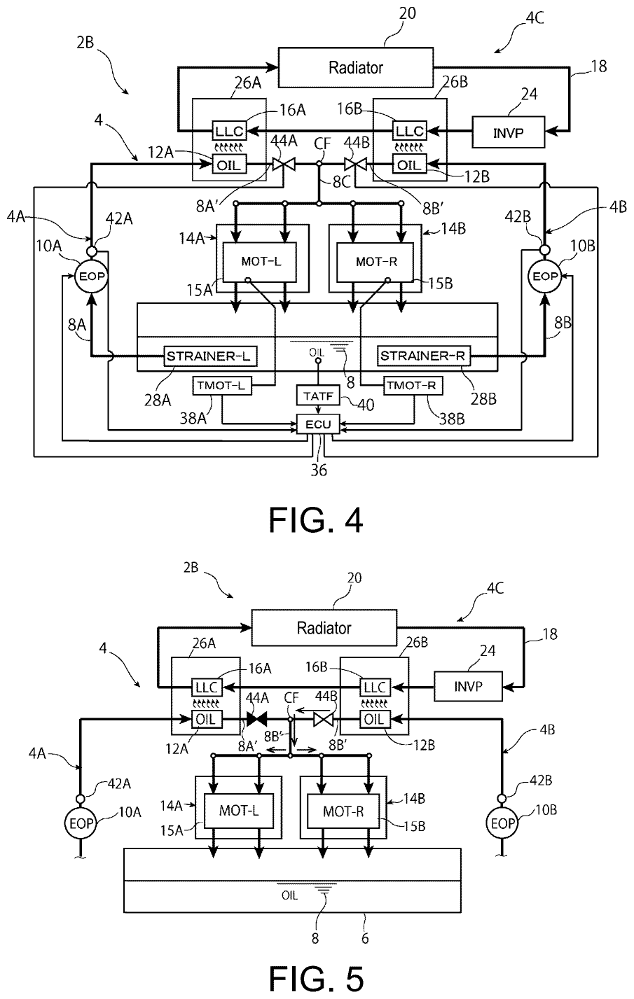

The second embodiment will be described with reference to FIG. 4 to FIG. 6. Parts that are identical or can be considered identical to those in the first embodiment are indicated by the same reference numerals, and description of structural and functional aspects already provided is omitted as appropriate (the same applies to other embodiments described below).

As shown in FIG. 4, a cooling circuit 4 of a vehicle driving apparatus 2B according to this embodiment includes, in addition to the configuration in FIG. 2, a first flow meter 42A as a first pump failure detection part arranged immediately downstream of the first pump 10A to detect failure of the first pump 10A, a second flow meter 42B as a second pump failure detection part arranged immediately downstream of the second pump 10B to detect failure of the second pump 10B, a first valve 44A arranged between the first heat exchanger 12A and the first cooled part 14A in the first cooling circuit 4A, a second valve 44B arranged between the second heat exchanger 12B and the second cooled part 14B in the second cooling circuit 4B, and a controller (ECU 36) that closes the first valve 44A when the first flow meter 42A detects failure of the first pump 10A and closes the second valve 44B when the second flow meter 42B detects failure of the second pump 10B. The detection values of the first flow meter 42A and the second flow meter 42B are input to the ECU 36. Both the first valve 44A and the second valve 44B are electromagnetic valves.

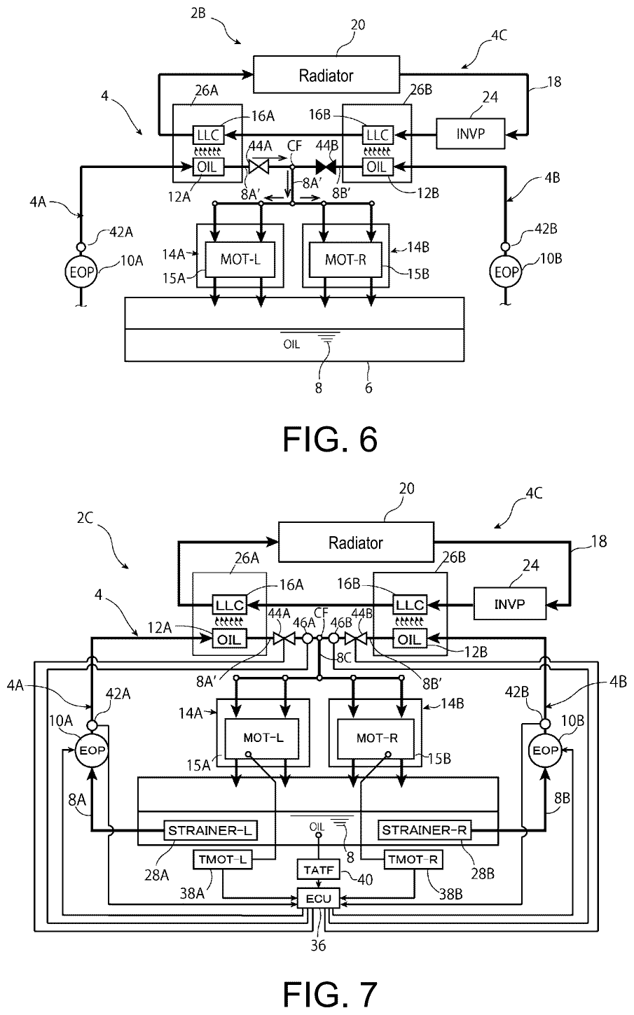

The ECU 36 determines that the first pump 10A has failed when the difference between the flow rate extruded by the first pump 10A (known) and the flow rate detected by the first flow meter 42A is outside a predetermined range. Similarly, the ECU 36 determines that the second pump 10B has failed when the difference between the flow rate extruded by the second pump 10B (known) and the flow rate detected by the second flow meter 42B is outside a predetermined range. When the ECU 36 determines that the first pump 10A has failed, the ECU 36 performs control to stop the driving of the first pump 10A and close the first valve 44A. In this case, as shown in FIG. 5, oil (the second refrigerant 8B′ that has passed through the second heat exchanger 12B) flows only in the second cooling circuit 4B, and this flow branches to cool the first cooled part 14A and the second cooled part 14B. Since cooling is performed only by the second refrigerant 8B′, the cooling temperatures of the first cooled part 14A and the second cooled part 14B become uniform, and no thermal unevenness occurs. When the ECU 36 determines that the second pump 10B has failed, the ECU 36 performs control to stop the driving of the second pump 10B and close the second valve 44B. In this case, as shown in FIG. 6, oil (the first refrigerant 8A′ that has passed through the first heat exchanger 12A) flows only in the first cooling circuit 4A, and this flow branches to cool the first cooled part 14A and the second cooled part 14B. Since cooling is performed only by the first refrigerant 8A′, the cooling temperatures of the first cooled part 14A and the second cooled part 14B become uniform, and no thermal unevenness occurs.

According to this embodiment, even if there is a malfunction in the first pump 10A or the second pump 10B, and one of the oil cooling circuits (the first cooling circuit 4A or the second cooling circuit 4B) does not function normally, the remaining oil cooling circuit can function as a backup. This enables temporary driving to a repair facility such as a dealer.

When the first flow meter 42A detects a failure of the first pump 10A, if there is spare capacity in the output of the second pump 10B, the ECU 36 may increase the output of the second pump 10B. When the second flow meter 42B detects a failure of the second pump 10B, if there is spare capacity in the output of the first pump 10A, the ECU 36 may increase the output of the first pump 10A. By doing so, it is possible to suppress the decrease in cooling efficiency due to the reduction in oil volume when cooling the first cooled part 14A and the second cooled part 14B with only the oil (the first refrigerant 8A′ or the second refrigerant 8B′) of a single oil cooling circuit. This can mitigate the temporary functional limitations when driving to a repair facility in case either the first pump 10A or the second pump 10B fails, and can suppress the amount of vehicle speed reduction.

The configuration may include a drive controller that reduces the functions of the first cooled part 14A and the second cooled part 14B when the first flow meter 42A detects a failure of the first pump 10A, and/or when the second flow meter 42B detects a failure of the second pump 10B. That is, the ECU 36 which also serves as a drive controller reduces the output of the motor 15A in the first cooled part 14A and the motor 15B in the second cooled part 14B by controlling the inverter 17. By doing so, it is possible to suppress a rapid decrease in cooling efficiency by adjusting the output to correspond to the reduced oil (the first refrigerant 8A′ or the second refrigerant 8B′) flow rate.

### Third Embodiment

The third embodiment will be described with reference to FIG. 7 to FIG. 9. As shown in FIG. 7, a cooling circuit 4 of a vehicle driving apparatus 2C according to this embodiment includes, in addition to the configuration shown in FIG. 4, a first flow rate sensor 46A that detects the oil flow rate in the first cooling circuit 4A, and a second flow rate sensor 46B that detects the oil flow rate in the second cooling circuit 4B. The controller (ECU 36) determines that the first cooling circuit 4A has failed and closes the first valve 44A when the first flow rate sensor 46A detects that the discharge flow rate of the first pump 10A falls to or below a level for a predetermined time or longer, and determines that the second cooling circuit 4B has failed and closes the second valve 44B when the second flow rate sensor 46B detects that the discharge flow rate of the second pump 10B falls to or below a level for a predetermined time or longer. It should be noted that the “flow meter” and “flow rate sensor” are distinguished only in expression, and there is no structural or functional difference therebetween.

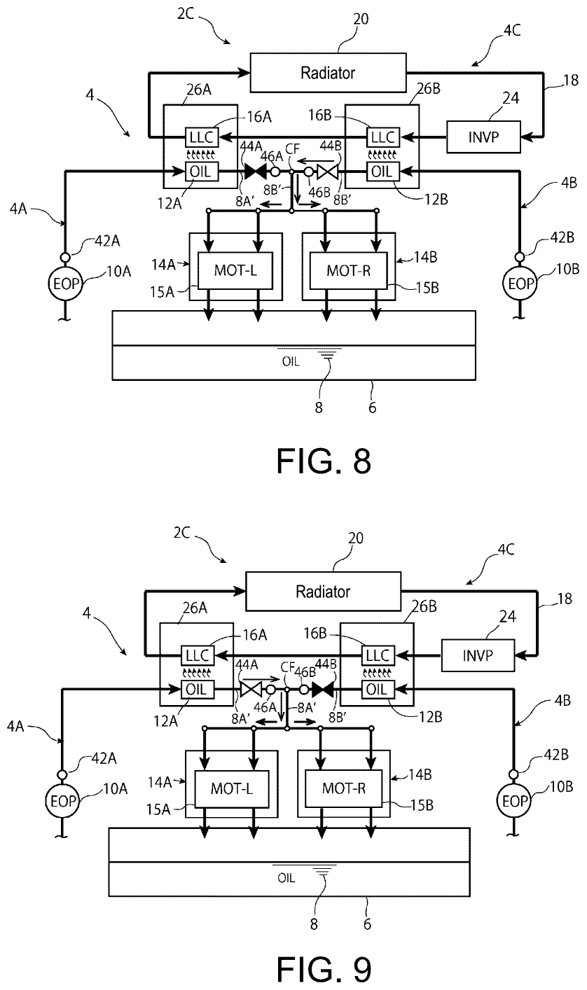

When the first flow rate sensor 46A detects that the discharge flow rate of the first pump 10A (known) falls to or below a level for a predetermined time or longer, the ECU 36 determines that the first cooling circuit 4A has failed, and performs control to stop the driving of the first pump 10A and close the first valve 44A. In this case, as shown in FIG. 8, oil (the second refrigerant 8B′ that has passed through the second heat exchanger 12B) flows only in the second cooling circuit 4B, and this flow branches to cool the first cooled part 14A and the second cooled part 14B. Since cooling is performed only by the second refrigerant 8B′, the cooling temperatures of the first cooled part 14A and the second cooled part 14B become uniform, and no thermal unevenness occurs. When the second flow rate sensor 46B detects that the discharge flow rate of the second pump 10B (known) falls to or below a level for a predetermined time or longer, the

ECU 36 determines that the second cooling circuit 4B has failed, and performs control to stop the driving of the second pump 10B and close the second valve 44B. In this case, as shown in FIG. 9, oil (the first refrigerant 8A′ that has passed through the first heat exchanger 12A) flows only in the first cooling circuit 4A, and this flow branches to cool the first cooled part 14A and the second cooled part 14B. Since cooling is performed only by the first refrigerant 8A′, the cooling temperatures of the first cooled part 14A and the second cooled part 14B become uniform, and no thermal unevenness occurs.

In the case where the first flow meter 42A or the second flow meter 42B does not detect a failure of the first pump 10A or the second pump 10B, and a failure of the first cooling circuit 4A or the second cooling circuit 4B is determined based on the first flow rate sensor 46A or the second flow rate sensor 46B, the ECU 36 determines that refrigerant leakage is occurring in the first cooling circuit 4A or the second cooling circuit 4B.

According to this embodiment, the first flow rate sensor 46A and the second flow rate sensor 46B are arranged at positions distant from the first pump 10A and the second pump 10B, thereby making it possible to detect not only a failure of the first pump 10A or the second pump 10B, but also refrigerant leakage in the first cooling circuit 4A or the second cooling circuit 4B in the case where the first pump 10A or the second pump 10B does not fail. This enables detailed identification of the parts that fail.

Although the embodiments of the disclosure have been described above, the disclosure is not limited to the above embodiments. Various modifications are possible within the scope of the claims, and the scope of the technical concept described in the specification and drawings. For example, while the above embodiments illustrate using parts from SMU to reduce the costs for TMU, it is possible to improve cooling efficiency even when designing new parts without using parts from SMU. Additionally, in FIG. 7, etc., the left-right positions of the first valve 44A and the first flow rate sensor 46A in the figure, and the positions of the second valve 44B and the second flow rate sensor 46B in the same direction may be reversed. Furthermore, while the above embodiments illustrate a configuration that detects failures of the first pump 10A and the second pump 10B by the first flow meter 42A and the second flow meter 42B, it is also possible to install oil pressure gauges downstream of the first pump 10A and the second pump 10B to determine a failure when the oil pressure deviates from a specified range. Moreover, it is possible to install current meters in the power circuits supplying electricity to the motors of the first pump 10A and the second pump 10B, which are electric oil pumps, and determine a failure when the current value deviates from a predetermined range. In addition, it is possible to install rotation speed meters on the motor shafts of the first pump 10A and the second pump 10B or the gear shafts of the gear pumps, and determine a failure when the rotation speed deviates from a predetermined range.

What is claimed is:

1. A cooling circuit, comprising:
a first cooling circuit comprising a first pump that pumps a refrigerant stored in a refrigerant storage part as a first refrigerant, a first heat exchanger that adjusts a temperature of the first refrigerant, and a first cooled part;
a second cooling circuit comprising a second pump that pumps the refrigerant stored in the refrigerant storage part as a second refrigerant, a second heat exchanger that adjusts a temperature of the second refrigerant, and a second cooled part; and
a third cooling circuit comprising a third pump that pumps a third refrigerant, a third heat exchanger that exchanges heat with the first heat exchanger, a fourth heat exchanger that exchanges heat with the second heat exchanger, and a fifth heat exchanger that adjusts a temperature of the third refrigerant,
wherein the third heat exchanger and the fourth heat exchanger are arranged in series in the third cooling circuit, and
the first cooling circuit and the second cooling circuit converge between a downstream side of the first heat exchanger and the second heat exchanger and an upstream side of the first cooled part and the second cooled part in a refrigerant circulation direction.

2. The cooling circuit according to claim 1, wherein the refrigerant is oil.

3. The cooling circuit according to claim 1, wherein the third refrigerant is a water-soluble refrigerant.

4. The cooling circuit according to claim 1, wherein the fifth heat exchanger is a radiator that exchanges heat with outside air.

5. The cooling circuit according to claim 1, wherein the first heat exchanger and the second heat exchanger have the same structure.

6. The cooling circuit according to claim 1, wherein the third heat exchanger and the fourth heat exchanger have the same structure.

7. The cooling circuit according to claim 1, wherein the first cooled part and/or the second cooled part is a motor.

8. The cooling circuit according to claim 1, wherein the first cooled part and the second cooled part are motors with the same structure.

9. The cooling circuit according to claim 1, wherein the first pump and the second pump are pumps with the same structure.

10. The cooling circuit according to claim 1, wherein the first pump and the second pump are electric pumps.

11. The cooling circuit according to claim 10, comprising:
a first pump failure detection part detecting a failure of the first pump;
a second pump failure detection part detecting a failure of the second pump;
a first valve arranged between the first heat exchanger and the first cooled part of the first cooling circuit;
a second valve arranged between the second heat exchanger and the second cooled part of the second cooling circuit; and
a controller configured to close the first valve in response to the first pump failure detection part detecting a failure of the first pump, and close the second valve in response to the second pump failure detection part detecting a failure of the second pump.

12. The cooling circuit according to claim 11, wherein the controller is configured to increase output of the second pump in response to the first pump failure detection part detecting a failure of the first pump, and increase output of the first pump in response to the second pump failure detection part detecting a failure of the second pump.

13. The cooling circuit according to claim 11, comprising:
a first flow rate sensor detecting an oil flow rate of the first cooling circuit; and
a second flow rate sensor detecting an oil flow rate of the second cooling circuit, wherein the controller is configured to determine that the first cooling circuit has failed and close the first valve in response to the first flow rate sensor detecting that a discharge flow rate of the first pump falls to or below a level for a predetermined time or longer, and determine that the second cooling circuit has failed and close the second valve in response to the second flow rate sensor detecting that a discharge flow rate of the second pump falls to or below a level for a predetermined time or longer.

14. A vehicle driving apparatus, comprising the cooling circuit according to claim 1.

15. A vehicle driving apparatus, comprising:
the cooling circuit according to claim 11; and
a drive controller configured to reduce functions of the first cooled part and the second cooled part in response to the first pump failure detection part detecting a failure of the first pump and/or in response to the second pump failure detection part detecting a failure of the second pump.
